(19) United States
(12) Patent Application Publication
(10) Pub. No.: US 2006/0239267 A1
(43) Pub. Date: Oct. 26, 2006

(54) User equipment in an IMS service network with a shortened PTT call setup time, IMS service network, and PTT call setup method therein

(75) Inventor: Joo-Yeon Ryu, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/410,898

(22) Filed: Apr. 26, 2006

(30) Foreign Application Priority Data
Apr. 26, 2005 (KR) 2005-34483

(51) Int. Cl. H04L 12/56

(52) U.S. Cl. 370/392; 370/401

(57) ABSTRACT

A User Equipment (UE) in an Internet Protocol Multimedia Subsystem (IMS) service network with a shortened Push-To-Talk (PTT) call setup time, an ISM service network, and a PTT call setup method therein are provided. In the UT, a transmitter requests from a Domain Name Server (DNS) an address of a Push-to-talk over Cellular (PoC) server. A receiver receives the address of the PoC server from the DNS. A controller directly provides a PTT call to the PoC server using the address. In the IMS service network, the PoC server directly receives the PTT call from an originating subscriber and delivers the PTT call to a destination subscriber. A Serving Call Session Control Function (S-CSCF) entity provides information about the destination subscriber to the PoC server. A home subscriber server stores subscriber addresses and provides the information about the destination subscriber. The DNS provides the address of the PoC server to the originating subscriber.

### CROSS-REFERENCE TO RELATED APPLICATIONS

This application claims priority under 35 U.S.C. § 119 to application Ser. No. 2005-34483 filed in the Korean Intellectual Property Office on Apr. 26, 2005, the entire disclosure of which is hereby incorporated by reference.

### BACKGROUND OF THE INVENTION

1. Field of the Invention

The present invention generally relates to an Internet Protocol Multimedia Subsystem (IMS) service network in which a Push-To-Talk (PTT) service is integrated and a PTT call setup method therein. More particularly, the present invention relates to an IMS service network capable of shortening a PTT call setup time and a PTT call process method therein.

2. Description of the Related Art

Mobile communication networks are developing with the further development of mobile communication technologies. As part of these developments, a next-generation mobile communication system (International Mobile Telecommunications-2000 (IMT-2000)) essentially provides an Internet service by providing a mobile Internet Protocol (IP) through which the Internet service can be received using an IMT-2000 network with unique IP addresses allocated from an Internet Service Provider (ISP). It is a trend that IP is being gradually accommodated in the mobile communication network. The IP is being established as a part of mobile communication network technology. A so-called “ALL IP NETWORK” concept has been introduced into the 3rd Generation Project Partnership 2 (3GPP2) in North America and 3GPP in Europe where IMT-2000 standardization is in progress. An ALL-IP network is included in a scope of the IMT-2000 network. However, such a network is a next-generation mobile communication network with a completely different infrastructure.

According to major design characteristics of 3GPP, a 3GPP network is the first network for supporting an IP multimedia service. To support the IP multimedia service, new nodes are added. These new nodes are referred to as the Internet Protocol Multimedia Subsystem (IMS).

That is, the IMS is a set of nodes newly introduced to provide the IEP multimedia service. The nodes of the IMS are a Call Session Control Server (or Call Session Control Function (CSCF) entity), a Home Subscriber Server (HSS), an Application Server (AS), and so on.

On the other hand, Push-To-Talk (PTT) is an instant messenger service such as a radio-type service that enables simple communication as soon as a switch is pressed to talk. The PTT can provide a faster communication service when compared with any service that has a waiting time in the conventional mobile phone.

When one person talks on a mobile phone in the case of a group target radio service in the PTT, many persons can listen to it on their mobile phones. This PTT service can overcome the limitations of one-to-one communication in the conventional mobile phone, and enables medium-scale group designation or communication as well as one-to-one radio communication.

Recently, an attempt is being made to introduce the PTT function into the conventional mobile phone coupled to an Internet messenger function. That is, when the PTT service is integrated in the IMS service network, it can immediately display whether an opposite side or user can make reception on a terminal screen, thereby increasing convenience.

FIG. 1 is a schematic block diagram illustrating a PTT service network integrated in a conventional Internet Protocol Multimedia Subsystem (IMS) service network.

Referring to FIG. 1, the PTT service network is provided with a User Equipment (UE) or terminal 10, an HSS 13, a CSCF entity, a Group List Management Server (GLMS) 15, and a Push-to-talk over Cellular (PoC) server 14. The HSS 13 stores all materials associated with subscriber data and performs an information management function for user profile management and UE mobility management, an authorization function, and so on. The CSCF entity controls a multimedia call on the basis of a Session Initiation Protocol (SIP). The GLMS 15, coupled to the UE and the CSCF entity, manages a list of group members through Hyper Text Transfer Protocol (HTTP). The PoC server 14 determines a type of a PTT call for a PTT service call operation in the IMS service and performs an operation linked to the GLMS 15, the CSCF entity, the HSS 13, and so on.

Herein, PoC is referred to as a Code Division Multiple Access (CDMA)-PTT service, and implements the PTT service function on an existing cellular phone or a Personal Communication System (PCS) phone. The PoC server 14 is provided with an AS 141 for performing a function for implementing a network for processing a call and a Media Relay Server (MRS) 142 for performing an actual voice data transmission at the time of implementing the network.

The CSCF entity is provided with a Proxy Call Session Control Function (P-CSCF) entity 11, a Serving Call Session Control Function (S-CSCF) entity 12, and an Interrogating Call Session Control Function (I-CSCF) entity (not illustrated). The P-CSCF entity 11 performs a function for registering a user from a visited network to a home network and transferring an outgoing/incoming call-related request in the place of something else. The S-CSCF entity 12 performs a function for actually processing a call-related request of the user in the home network. The I-CSCF entity performs a function for selecting one S-CSCF entity 12 suitable for the call-related request of the user from among a plurality of S-CSCF entities 12, and preventing configuration information of the S-CSCF entity 12 located in the home network from being shown to other networks for security.

The HSS 13 uses a Diameter protocol along with the PoC server 14, the S-CSCF entity 12, and so on. The MRS 142 uses Real-Time Transport Protocol (RTP) along with the UE 10. On the other hand, Real-Time Transport Control Protocol (RTCP) is an RTP control protocol.

When a PTT call is transmitted in the structure of FIG. 1, an “INVITE” packet in an SIP request message sent from the UE 10 is transferred to the AS 141 via the P-CSCF entity 11 and the S-CSCF entity 12. The “INVITE” packet is required to initiate a call between a client and a server, and is used in a method for allowing the user to join a session. At this time, the S-CSCF entity 12 asks the HSS 13 for information about a subscriber making a call attempt in order to route the “INVITE” packet, and then sets the AS 141 capable of processing a call by using the information.

When an originating subscriber sends a call-related request in the visited network rather than the home network, the request is delivered to the AS 141 via the P-CSCF entity 11, the I-CSCF entity (not illustrated), and the S-CSCF entity 12.

When the PTT call is received, an “INVITE” packet to be transmitted from a destination UE passes through the AS 141, the S-CSCF entity 12, the P-CSCF entity 11, and the UE 10. Information about a destination subscriber is to be retrieved in the HSS 13 such that the packet can be delivered to the S-CSCF entity in which location information of the destination subscriber is stored.

FIG. 2 illustrates a call setup operation in the PTT service network of FIG. 1, and FIG. 3 illustrates a flow of the call setup operation of FIG. 2.

The call setup process in the conventional PTT service network will be described in detail with reference to FIGS. 2 and 3.

In FIG. 2, “A1” and “A2” denote networks for initiating a call transmission. The “A1” network is a home network, and the “A2” network is a visited network. “B” denotes a destination network.

In FIGS. 2 and 3, arrows “a” through “j” denote steps in the call setup process from an originating UE to a destination UE.

In FIG. 3, P-CSCF1 indicates P-CSCF_A1 and P-CSCF_A2, I-CSCF1 indicates I-CSCF_A1 and I-CSCF_A2, and S-CSCF1 indicates S-CSCF_A1 and S-CSCF_A2. Also, S-CSCF2, I-CSCF2, and P-CSCF2 indicate S-CSCF_B, I-CSCF_B, and P-CSCF_B, respectively.

After acquiring an address of P-CSCF_A1 for a call-related request through a query to a Domain Name Server (DNS), UE1 transmits a call using the address of P-CSCF_A1 as indicated by “a”.

At this time, P-CSCF_A1 determines whether UE1 is a subscriber located in the home network or a subscriber located in the visited network. If UE1 is located in the visited network, P-CSCF_A1 transmits the call to I-CSCF_A1 as indicated by “b”.

I-CSCF_A1 asks the HSS an address of S-CSCF A2 for processing the call of UE1 as indicated by “c”. The HSS delivers the address of S-CSCF_A2 for processing the call of the UE1 as indicated by “d”, to I-CSCF_A1.

If UE1 is located in the home network as a determination result of P-CSCF_A1, the call of UE1 is delivered to an associated S-CSCF_A2 as indicated by “d” because P-CSCF_A1 knows the address of S-CSCF_A2 for processing the call of UE1.

After analyzing the delivered call, S-CSCF_A2 obtains an address of a PoC_A2(i.e. Application Server (AS)) server from the HSS by asking the HSS the address of the PoC_A2 server when the call is a PTT call transmitted from UE1, as indicated by “e”. S-CSCF_A2 delivers the PTT call to the associated PoC_A2 server as indicated by “f”.

Upon receiving the PTT call, the PoC_A2 server determines a type of the PTT call. That is, the determination is made as to whether the PTT call is a 1:1 call or a 1:N group call. If the PTT call is the group call, the PoC_A2 server requests that the GLMS retrieve members and then receives information about the retrieved members as indicated by “g”.

Subsequently, the PoC_A2 server requests that S-CSCF_A2 deliver the call to UE2 corresponding to the destination UE, and S-CSCF_A2 asks the HSS an address of S-CSCF_B for delivering the call to UE2 to receive the address of S-CSCF_B as indicated by “h”.

When S-CSCF_A2 and S-CSCF_B are in different domains, i.e., different home or visited networks, S-CSCF_A2 acquires the address of S-CSCF_B from the HSS through I-CSCF_A2.

Upon acquiring the address of S-CSCF_B, S-CSCF_A2 delivers the call destined for UE2 to S-CSCF_B as indicated by “i”. S-CSCF_B delivers the call destined for UE2 to P-CSCF_B as indicated by “j”. P-CSCF_B delivers the call to UE2 as indicated by “k”.

A reply to the call is transmitted to UE1 corresponding to the originating subscriber along a path of “l”˜“q” opposite to the above-described path.

When the above-described call processing procedure is completed, an RTP connection is established to transmit IMS media traffic between UE1 and UE2, and communication is performed through the MRS located in the PoC server.

As described above, it can be seen that a plurality of servers such as P-CSCF (or I-CSCF) and S-CSCF entities, and so on must conventionally operate for the PTT call setup procedure between two UEs, and must perform a process for acquiring associated information from the HSS.

That is, it can be seen that a process may be unnecessarily performed in the PTT call setup procedure when the PTT service is applied to the IMS service network.

There is an advantage in that the PTT can provide a faster communication service as compared with any service with a waiting time in the conventional mobile phone. However, this advantage is degraded by a call setup time delayed due to the unnecessary process.

Accordingly, there is a need for an improved IMS service network with a shortened PTT call setup time and a method for implementing the improved PTT call setup.

### SUMMARY OF THE INVENTION

Accordingly, the present invention has been designed to address the above and other problems occurring in the prior art. Therefore, it is an object of the present invention to provide user equipment in an Internet Protocol Multimedia Subsystem (IMS) service network with a shortened Push-To-Talk (PTT) call setup time, an IMS service network, and a PTT call setup method therein.

In accordance with an exemplary aspect of the present invention, there is provided user equipment for use in an Internet Protocol Multimedia Subsystem (IMS) service network, comprising a transmitter for requesting from a Domain Name Server (DNS) an address of an associated Push-to-talk over Cellular (PoC) server for a Push-To-Talk (PTT) call-related request from an originating subscriber, a receiver for receiving the address of the associated PoC server from the DNS and a controller for directly providing a PTT call to the associated PoC server using the address of the associated PoC server.

In accordance with another exemplary aspect of the present invention, there is provided an Internet Protocol Multimedia Subsystem (IMS) service network, comprising a Push-to-talk over Cellular (PoC) server for directly receiving a Push-To-Talk (PTT) call from an originating subscriber and delivering the PTT call to an associated destination subscriber, a Serving Call Session Control Function (S-CSCF) entity for providing information about the associated destination subscriber to the PoC server, a Home Subscriber Server (HSS) for storing a plurality of subscriber addresses and providing the information about the associated destination subscriber when a request of the S-CSCF entity is made and a Domain Name Server (DNS) for providing an address of an associated PoC server for a PTT call-related request to the originating subscriber having a query.

In accordance with yet another exemplary aspect of the present invention, there is provided a method for setting up a Push-To-Talk (PTT) call in an Internet Protocol Multimedia Subsystem (IMS) service network, comprising the steps of acquiring an address of a Push-to-talk over Cellular (PoC) server for a PTT call-related request from an originating subscriber, transmitting a PTT call to the PoC server whose address has been acquired, determining a type of the PTT call, requesting from a Serving Call Session Control Function (S-CSCF) entity an address of an associated destination subscriber when the PTT call is a 1:1 call, providing the address of the associated destination subscriber from the S-CSCF entity to the PoC server when the address of the associated destination subscriber is present in the S-CSCF entity and delivering the PTT call to the associated destination subscriber through the PoC server.

Therefore, the present invention can significantly reduce the number of servers to be used at a PTT call setup time in the IMS service network by directly delivering a PTT call to an address of the PoC server (concretely, an Application Server (AS) of the PoC server) acquired through a query to the DNS without delivering the PTT call to a Proxy Call Session Control Function (P-CSCF) entity when the PTT call is generated from the originating user terminal or equipment. Herein, the HSS stores the subscriber addresses.

### BRIEF DESCRIPTION OF T HE DRAWINGS

The above and other objects, aspects, and features of exemplary embodiments of the present invention will be more clearly understood from the following detailed description taken in conjunction with the accompanying drawings, in which:

FIG. 1 is a schematic block diagram illustrating a Push-To-Talk (PTT) service network integrated in a conventional Internet Protocol Multimedia Subsystem (IMS) service network;

FIG. 2 illustrates a call setup operation in the PTT service network of FIG. 1;

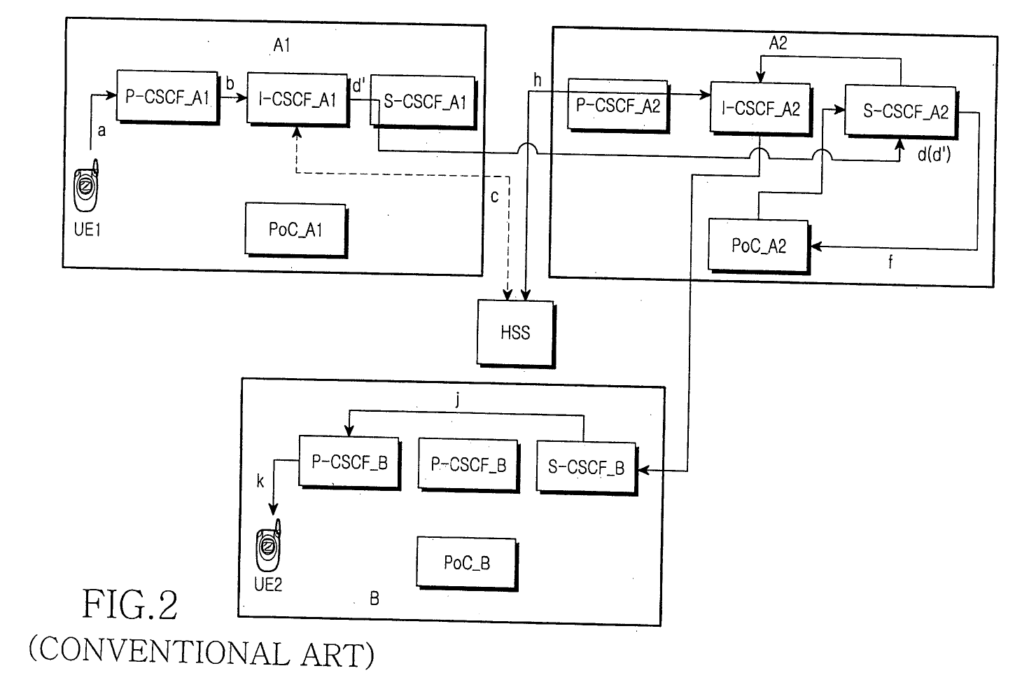

FIG. 3 illustrates a flow of the call setup operation of FIG. 2;

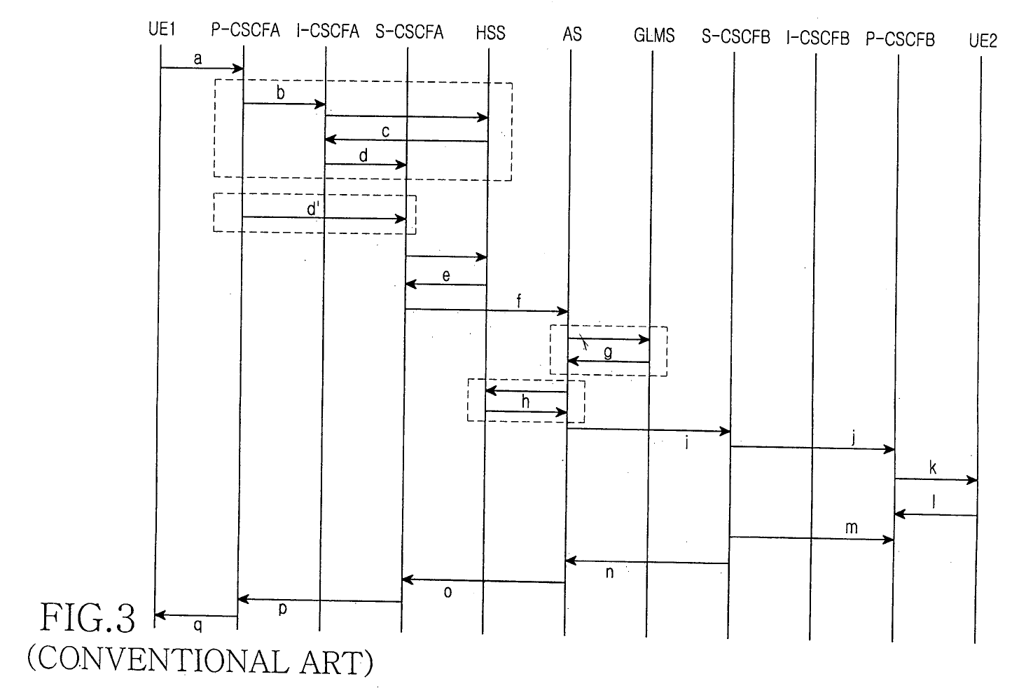

FIG. 4 is a schematic block diagram illustrating a PTT service network integrated in an IMS service network in accordance with an exemplary embodiment of the present invention;

FIG. 5 illustrates a call setup operation in the PTT service network of FIG. 4;

FIG. 6 illustrates a flow of the call setup operation of FIG. 5;

FIG. 7 is a flowchart illustrating a PTT call setup process in the IMS service network in accordance with an exemplary embodiment of the present invention; and

FIG. 8 is a block diagram illustrating User Equipment (UE) for use in the IMS service network in an exemplary embodiment of the present invention.

Throughout the drawings, the same drawing reference numerals will be understood to refer to the same elements, features and structures.

### DETAILED DESCRIPTION OF THE EXEMPLARY EMBODIMENTS

Exemplary embodiments of the present invention will be described in detail herein below with reference to the accompanying drawings such that those skilled in the art can readily implement the present invention.

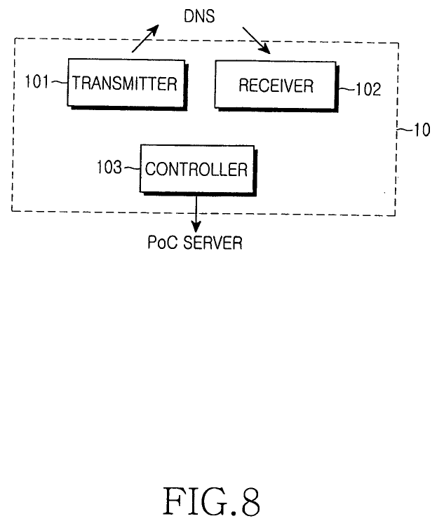

FIG. 8 is a block diagram illustrating a User Equipment (UE) for use in an Internet Protocol Multimedia Subsystem (IMS) service network in accordance with an exemplary embodiment of the present invention.

Referring to FIG. 8, the UT 10 for use in an IMS service network is provided with a transmitter 101 for requesting from a Domain Name Server (DNS) an address of an associated Push-to-talk over Cellular (PoC) server for processing a Push-To-Talk (PTT) call according to a request of an originating subscriber, a receiver 102 for receiving the address of the associated PoC server from the DNS, and a controller 103 for directly providing the PTT call to the associated PoC server.

When an incoming PTT call is received, the receiver 102 directly receives the PTT call from the PoC server. After the originating subscriber logs in, the transmitter 101 requests from the DNS the address of the associated PoC server for a PTT call-related request. Subsequently, the receiver 102 receives the address of the associated PoC server from the DNS.

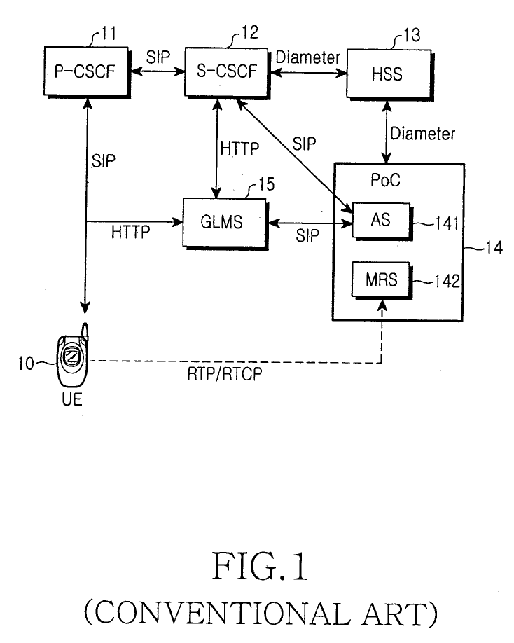

The controller 103 controls the transmitter 101 to send the PTT call-related request to the address of the PoC server (denoted by reference numeral 14 in FIG. 1) received from the DNS. That is, the controller 103 controls the transmitter 101 to provide information about the subscriber UT 10 to a Serving Call Session Control Function (S-CSCF) entity according to the PTT call. The S-CSCF entity of the IMS service network delivers a PTT call-related request message to a Home Subscriber Server (HSS) which stores a plurality of subscriber addresses in accordance with the present invention. When the S-CSCF entity makes a request, the HSS provides information about an associated destination subscriber to the S-CSCF entity. At this time, specially set protocols are used between the PoC server for processing the PTT call and the subscriber UT and between the PoC server and the S-CSCF entity, respectively.

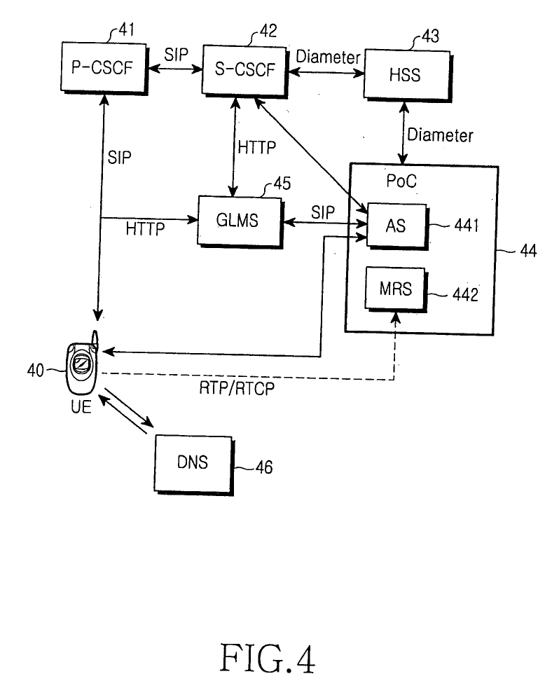

FIG. 4 is a schematic block diagram illustrating a PTT service network integrated in the IMS service network in accordance with an exemplary embodiment of the present invention.

Referring to FIG. 4, the PTT service network in accordance with the exemplary embodiment of the present invention is provided with a UT 40, an HSS 43, a CSCF entity, a Group List Management Server (GLMS) 45, a PoC server 44, and a DNS 46. The UT 40 directly transfers a call to the PoC server 44. The HSS 43 stores all materials associated with subscriber data and performs an information management function for user profile management and UT mobility management, an authorization function, and so on. The CSCF entity controls a multimedia call on the basis of a Session Initiation Protocol (SIP). The GLMS 45, coupled to the UT and the CSCF entity, manages a list of group members through Hyper Text Transfer Protocol (HTTP). The PoC server 44 determines a type of a PTT call for a PTT service call operation in the IMS service network and performs an operation linked to the GLMS 45, the CSCF entity, the HSS 43, and so on. When receiving a query for directly transferring the call from the UT 40 to the PoC server 44, the DNS 46 provides an address of the associated PoC server 44 (concretely, an Application Server (AS) 441) to the UT 40.

A proper protocol is to be set between the UT 40 and the AS 441 such that a call-related request is sent from the UT 40 to the AS 441. This is also applied between the AS 441 and an S-CSCF entity 42. The proper protocol can be variously set according to an associated system.

The PoC server 44 is provided with the AS 441 for performing a function for implementing a network for processing the call and a Media Relay Server (MRS) 442 for performing an actual voice data transmission at the time of implementing the network.

The CSCF is provided with a Proxy Call Session Control Function (P-CSCF) entity 41, an S-CSCF entity 42, and an Interrogating Call Session Control Function (I-CSCF) entity (not illustrated). The P-CSCF entity 41 performs a function for registering a user from a visited network to a home network and transferring an outgoing/incoming call-related request in the place of something else. The S-CSCF entity 42 performs a function for actually processing a call-related request of the user in the home network. The I-CSCF performs a function for selecting one S-CSCF entity 42 suitable for the call-related request of the user from among a plurality of S-CSCF entities 42, and preventing configuration information of the S-CSCF entity 42 located in the home network from being shown to other networks for security.

The HSS 43 uses a Diameter protocol along with the PoC server 44, the S-CSCF entity 42, and so on. The MRS 442 uses Real-Time Transport Protocol/Real-Time Transport Control Protocol (RTP/RTCP) along with the UT 40.

When a PTT call is conventionally transmitted, an “INVITE” packet in an SIP request message sent from the UT 40 is transferred to the AS 441 via the P-CSCF entity 41, the I-CSCF entity (in the case of the visited network), and the S-CSCF entity 42. The S-CSCF entity 42 requests from the HSS 43 information about a subscriber making a call attempt in order to route the “INVITE” packet, and then sets the AS 441 capable of processing a call through the information.

However, the UT 40 directly transfers the PTT call to the AS 441 in an exemplary embodiment of the present invention. Exemplary embodiments of the present invention are different from the prior art in that the HSS 43 may store an address of the subscriber and the DNS 46 is further provided which can give notification of an associated AS 441 when a query is sent from the UT 40.

Accordingly, the UT 40 of an exemplary embodiment acquires an address of the PoC server 44 present in the visited network from the DNS 46 through a query, regardless of an address of the PoC server 44 present in the home network. Therefore, there is no limitation that requires the UT 40 to upload the PTT call to the PoC server 44 present in the home network. That is, the UT 40 can transfer the PTT call to the associated AS 441 through the query to the DNS 46.

When the UT 40 logs in, the S-CSCF entity 42 sends a PTT call-related request to the associated AS 441 using information about the UT stored in the HSS 43, such that a login procedure is completed in accordance with an exemplary embodiment of the present invention. When the UT 40 logs in, it does not need to perform a conventional operation for updating subscriber information with the HSS 43 through the P-CSCF, I-CSCF, and S-CSCF entities. This is advantageous in that the system of an exemplary embodiment does not need to perform a conventional 3rd party registration procedure for notifying the associated AS 441 that the UT 40 has logged in after a reply message has been received through the S-CSCF, I-CSCF, and P-CSCF entities.

In an exemplary embodiment of the present invention, the AS 441 cannot determine whether the UT 40 has logged in before a PTT call is transmitted.

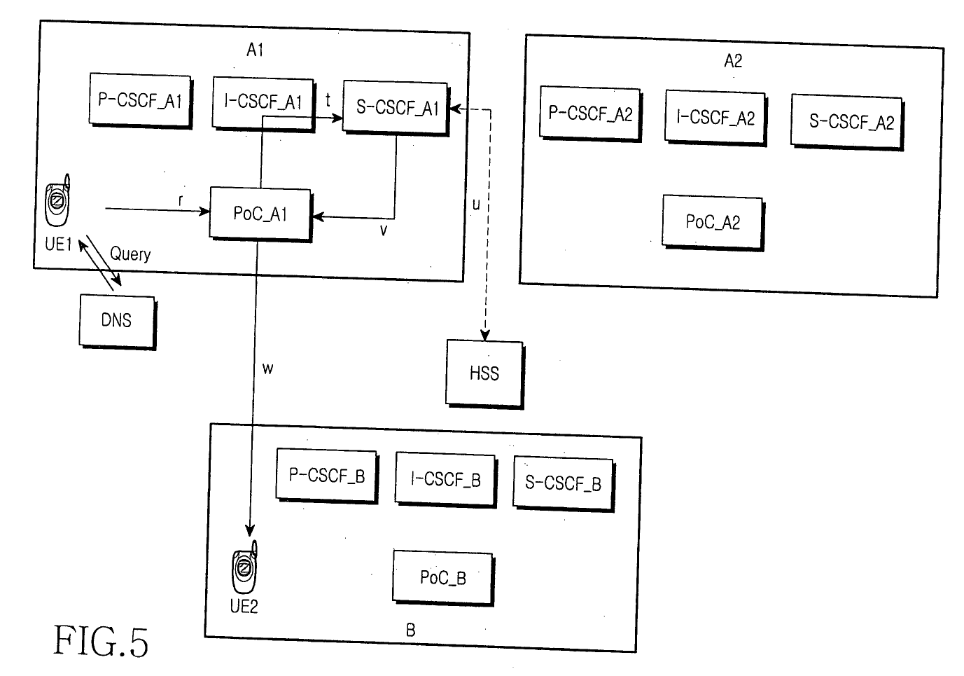

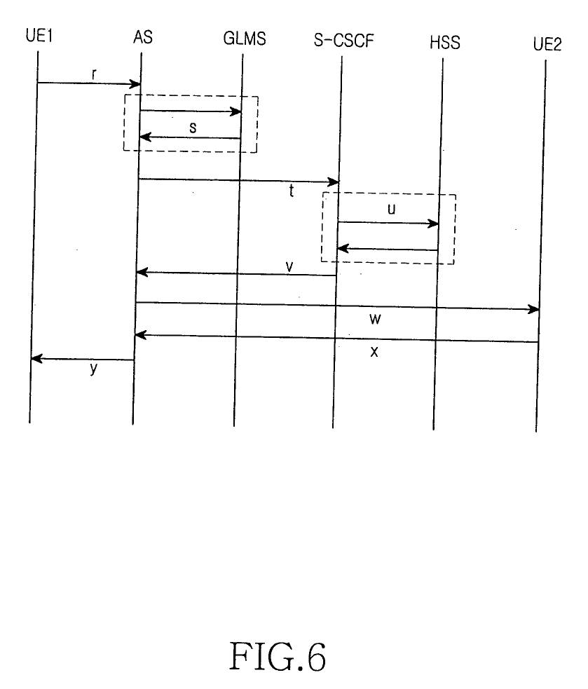

FIG. 5 illustrates a call setup operation in the PTT service network of FIG. 4, and FIG. 6 illustrates a flow of the call setup operation of FIG. 5.

Next, the call setup process in the PTT service network in accordance with an exemplary embodiment of the present invention will be described in detail with reference to FIGS. 5 and 6.

In FIG. 5, “A1” and “A2” denote networks for initiating a call transmission. The “A1” network is a visited network, and the “A2” network is a home network. “B” denotes a destination network.

In FIGS. 5 and 6, arrows “r” through “w” denote the call setup process from an originating terminal (UTI) to a destination terminal (UT2).

After acquiring an address of a PoC_A1 server for a call-related request through a query to the DNS, UTI transmits a PTT call to the associated PoC_A1 server as indicated by “r”.

In an exemplary embodiment, UTI directly sends the PTT call-related request to the PoC_A1 server using the address acquired through the query to the DNS without passing through the IMS service network configured by P-CSCF_A1, I-CSCF_A1, and S-CSCF_A1.

Upon receiving the PTT call-related request, the PoC_A1 server determines a type of the PTT call. That is, the determination is made as to whether the PTT call is a 1:1 call or a 1:N group call. If the PTT call is a group call, the PoC-A1 server requests that the GLMS retrieve members and then receives information about the retrieved members as indicated by “s”.

Subsequently, the PoC_A1 server retrieves location information about UT2 corresponding to the destination terminal from S-CSCF_A1 as indicated by “t”. Because UT2 logs in to a different domain, S-CSCF_A1 retrieves an address of UT2 from the HSS as indicated by “u”.

S-CSCF_A1 acquires the address of UT2 through a query to the HSS and then delivers the address of UT2 to the PoC_A1 server as indicated by “v”. The PoC_A1 server delivers the PTT call to UT2 as indicated by “w”.

A reply to the call is transmitted to UTI corresponding to the originating subscriber along a path of “x” and “y” opposite to the above-described path.

When the above-described call processing procedure is completed, an RTP connection is established to transmit IMS media traffic between UTI and UT2, and communication between the UTs is performed through the MRS located in the PoC server.

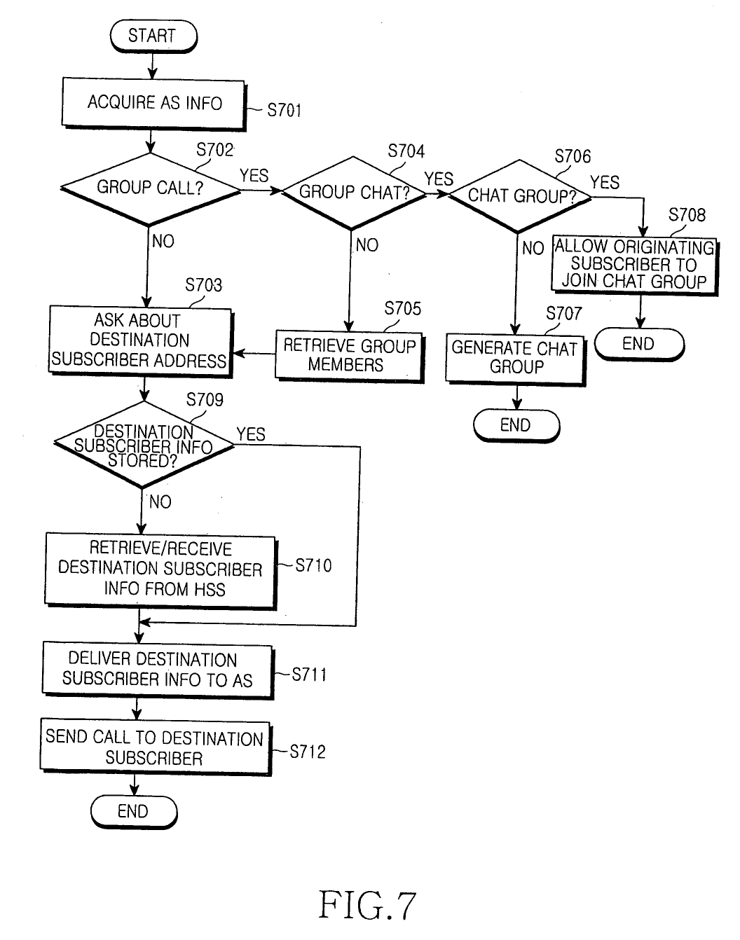

FIG. 7 is a flowchart illustrating a PTT call setup process in the IMS service network in accordance with an exemplary embodiment of the present invention. The PTT call setup process will be described with reference to FIG. 7.

When the UT logs in, the S-CSCF entity stores subscriber information only in the HSS, such that the login procedure is completed. As described above, the 3rd party registration is not performed.

After acquiring an address of an associated PoC server for a call-related request through a query to the DNS, the UT sends a PTT call to the associated PoC server (Step S701).

Upon receiving a PTT call-related request from the UT, the PoC server determines a PTT call type (or a PoC session type) (Step S702). That is, the determination is made as to whether the PTT call is a 1:1 call or a 1:N group call.

If the PoC session type is not a group call, the PoC server requests from the S-CSCF entity an address of a destination subscriber (UT) (Step S703).

However, if the PoC session type is the group call, the PoC server determines whether the group type is a group chat (Step S704). If the group type is not the group chat, the PoC server requests that the GLMS retrieve members, receives a retrieval result, and requests from the S-CSCF entity an address of a destination subscriber (UT) (Steps S705 and S703).

If the group type is the group chat, a determination is made as to whether a chat group is present (Step S706). If a chat group is absent, the chat group can be generated (Step S707). However, if the chat group is present, an originating subscriber can join the chat group (Step S708).

Upon receiving a query for the address of the destination subscriber from the PoC server (Step 709), the S-CSCF entity delivers the address of the destination subscriber to the AS of the PoC server when storing information about the destination subscriber (Step S711). When not storing information about the destination subscriber, the S-CSCF entity requests from the HSS the address of the destination subscriber (Step S710). Then, the S-CSCF entity acquires the address of the destination subscriber and delivers the acquired address to the AS (Step S711).

Upon receiving the address of the destination subscriber, the PoC server directly delivers the PTT call to the destination subscriber (Step S712). The PoC server sends, to the originating subscriber, a reply to the PTT call.

Through exemplary embodiments as described above, it can be seen that the a call set up time can be reduced because a UT directly transfers a PTT call to an AS without passing through a P-CSCF entity when the PTT call is set up in an IMS service network.

As is apparent from the above exemplary embodiments, competition of an IMS network service in which a PTT service is integrated can be improved by reducing a PTT call setup time in an IMS service network and achieving a fast connection corresponding to the advantage of the PTT service.

Although exemplary embodiments of the present invention have been disclosed for illustrative purposes, the present invention is not limited to the above-described embodiments. Those skilled in the art will appreciate that various modifications, additions, and substitutions are possible, without departing from the spirit and scope of the invention as defined by the appended claims and the full scope of equivalents thereof.

What is claimed is:

1. A user equipment (UE) for use in an Internet Protocol Multimedia Subsystem (IMS) service network, comprising:
a transmitter for requesting from a Domain Name Server (DNS) an address of an associated Push-to-talk over Cellular (PoC) server for a Push-To-Talk (PTT) call-related request from an originating subscriber;
a receiver for receiving the address of the associated PoC server from the DNS; and
a controller for providing a PTT call to the associated PoC server using the address of the associated PoC server.

2. The user equipment of claim 1, wherein the receiver receives a PTT call from the PoC server when the PTT call is received.

3. The user equipment of claim 1, wherein the originating subscriber requests from the DNS the address of the associated PoC server for the PTT call-related request after a login, and receives the address of the associated PoC server from the DNS.

4. The user equipment of claim 3, wherein the PoC server provides information about a destination subscriber to a Serving Call Session Control Function (S-CSCF) entity, a Home Subscriber Server (HSS) stores a plurality of subscriber addresses, and information about an associated destination subscriber is provided to the S-CSCF entity when a request of the S-CSCF entity is made.

5. The user equipment of claim 4, wherein set protocols are used between the PoC server and the subscriber UT and between the PoC server and the S-CSCF entity, respectively.

6. An Internet Protocol Multimedia Subsystem (IMS) service network, comprising:
a Push-to-talk over Cellular (PoC) server for directly receiving a Push-To-Talk (PTT) call from an originating subscriber and delivering the PTT call to an associated destination subscriber;
a Serving Call Session Control Function (S-CSCF) entity for providing information about the associated destination subscriber to the PoC server;
a Home Subscriber Server (HSS) for storing a plurality of subscriber addresses and providing the information about the associated destination subscriber when a request of the S-CSCF entity is made; and
a Domain Name Server (DNS) for providing an address of an associated PoC server for a PTT call-related request to the originating subscriber having a query.

7. The IMS service network of claim 6, further comprising:
a user equipment for requesting from the DNS the address of the associated PoC server for the PTT call-related request after the originating subscriber logs in, and receiving the address of the associated PoC server from the DNS.

8. The IMS service network of claim 6, further comprising:
a Group List Management Server (GLMS) for storing information about group subscribers, and providing the information about the group subscribers to the S-CSCF entity when a request of the S-CSCF entity is made.

9. The IMS service network of claim 6, wherein the PoC server comprises:
an application server (AS) for setting up the PTT call; and
a Media Relay Server (MRS) for setting up a connection of a protocol for an IMS media traffic transmission between the originating subscriber and the destination subscriber when the PTT call is set up, and enabling voice data transmission.

10. The IMS service network of claim 9, wherein the protocol is a Real-time Transport Protocol (RTP).

11. The IMS service network of claim 6, wherein especially set protocols are used between the PoC server and the subscriber and between the PoC server and the S-CSCF entity, respectively.

12. A method for setting up a Push-To-Talk (PTT) call in an Internet Protocol Multimedia Subsystem (IMS) service network, comprising the steps of:
acquiring an address of a Push-to-talk over Cellular (PoC) server for a PTT call-related request from an originating subscriber;
transmitting a PTT call to the PoC server whose address has been acquired;
determining a type of the PTT call;
requesting from a Serving Call Session Control Function (S-CSCF) entity an address of an associated destination subscriber when the PTT call is a 1:1 call;
providing the address of the associated destination subscriber from the S-CSCF entity to the PoC server when the address of the associated destination subscriber is present in the S-CSCF entity; and
delivering the PTT call to the associated destination subscriber through the PoC server.

13. The method of claim 12, wherein the step of acquiring the address of the PoC server comprises the steps of:
sending a query for the address of the PoC server from the originating subscriber to a Domain Name Server (DNS); and
receiving the address of the PoC server from the DNS.

14. The method of claim 13, wherein the step of acquiring the address of the PoC server comprises the steps of:
receiving, by the S-CSCF entity, the address of the associated destination subscriber from a Home Subscriber Server (HSS), the HSS storing the address of the associated destination subscriber.

15. The method of claim 12, wherein when the PTT call is a 1 :N call, the PoC server determines whether the PTT call is a group chat.

16. The method of claim 15, wherein when the PTT call is the group chat, a determination is made as to whether a chat group is present.

17. The method of claim 16, further comprising the step of:
determining whether to allow the originating subscriber to join the chat group when the chat group is present.

18. The method of claim 16, further comprising the step of:
determining whether to generate the chat group when the chat group is absent.

19. The method of claim 15, wherein the PoC server requests from the S-CSCF entity the address of the destination subscriber after requesting that a Group List Management Server (GLMS) retrieve members.

20. The method of claim 12, wherein the PoC server comprises:
an application server (AS) for setting up the PTT call; and
a Media Relay Server (MRS) for setting up a connection of a protocol for an IMS media traffic transmission between the originating subscriber and the destination subscriber when the PTT call is completely set up, and enabling an actual voice data transmission.

21. The method of claim 20, wherein the protocol is a Real-time Transport Protocol (RTP).

22. The method of claim 12, wherein especially set protocols are used between the PoC server and the subscriber and between the PoC server and the S-CSCF entity, respectively.
